(19) United States
(12) Patent Application Publication
(10) Pub. No.: US 2012/0285438 A1
(43) Pub. Date: Nov. 15, 2012

(54) Football helmet barbecue grill

(76) Inventor: Robert Arnold Serrano, Whittier, CA (US)

(21) Appl. No.: 13/068,533

(22) Filed: May 14, 2011

(51) Int. Cl. A47J 37/07

(52) U.S. Cl. 126/25 R

(57) ABSTRACT

A Football Helmet Barbecue Grill includes a Football Shaped Hood, a Base Assembly, and a Grill Assembly. The Grill Assembly is affixed with the Base Assembly. In some preferred embodiments, the Base Assembly is removed to form a Football Themed Hibachi Grill with a handle affixed to the top of the Football Shaped Hood.

### FIELD OF THE INVENTION

The present invention is in the area of cooking and sports, and more particularly pertains to a football helmet-shaped grill.

### BACKGROUND OF THE INVENTION

In the USA, football is indisputably America's favorite sport. Whether it is high school, collegiate, or the NFL, fans from all ages, demographics, and backgrounds are transfixed on the progress of their favorite ballclubs.

This frenzy for football has created a multi-billion dollar industry. Flowing from this industry is a panoply of various niche products. Football accessories can range from trading cards, coffee mugs, ties, cuff-links, stickers, to even credit cards.

This love affair with football is manifested each weekend at stadiums across the country. Per tradition, football fans bring their barbecue grills to prepare lunch or dinner in the parking lots typically before kickoff. This ritual typically entails various activities to show one's allegiance to their beloved team.

However, one of the problems with these rituals is the fact that some barbecue grills brought into the parking lots by fans are not safe. And other grills can leave behind residual ash, and other litter.

Therefore, what is clearly needed in the art is an apparatus which enables one to barbecue their tailgating parties with a football-helmet grill. Such an apparatus should be made to be portable, safe, and easy to tote in a typical automobile.

### SUMMARY OF THE INVENTION

It is an object of the present invention to provide an apparatus to be stable an safe for the purposes of barbecuing food at a tailgating party. This grill incorporates a football-shaped helmet which is articulably hinged with the grill assembly.

It is an object of the present invention to provide a football-themed grill to enable a fan to show their team spirit while providing a state of the art designed grill. The present invention can incorporate gas-powered grills in some preferred embodiments.

### BRIEF DESCRIPTION OF THE DRAWING FIGURES

FIG. 1 is an elevation side view of a preferred embodiment of the present invention.

FIG. 2 is an elevation rear view of a preferred embodiment of the present invention.

FIG. 3 is an elevation frontal view of a preferred embodiment of the present invention.

FIG. 4 is an exploded view of a preferred embodiment of the present invention.

FIG. 5 is elevated transparent view of a preferred embodiment of the present invention.

FIG. 6 is an elevation side view of a preferred embodiment of the present invention.

FIG. 7 is a plan view of a preferred embodiment of the present invention.

FIG. 8 is an elevation side view of a preferred embodiment of the present invention.

FIG. 9 is an elevation rear view of a preferred embodiment of the present invention.

FIG. 10 is an elevation frontal view of a preferred embodiment of the present invention.

FIG. 11 is an elevation side view of a preferred embodiment of the present invention.

FIG. 12 is an elevation rear view of a preferred embodiment of the present invention.

FIG. 13 is an elevation frontal view of a preferred embodiment of the present invention.

FIG. 14 is elevated transparent view of a preferred embodiment of the present invention.

FIG. 15 is an elevation side view of a preferred embodiment of the present invention.

FIG. 16 is a plan view of a preferred embodiment of the present invention.

FIG. 17 is an elevation side view of a preferred embodiment of the present invention.

FIG. 18 is an elevation rear view of a preferred embodiment of the present invention.

FIG. 19 is an elevation frontal view of a preferred embodiment of the present invention.

FIG. 20 is an elevation side view of a preferred embodiment of the present invention.

FIG. 21 is an elevation rear view of a preferred embodiment of the present invention.

### DESCRIPTION OF PREFERRED EMBODIMENTS

According to a preferred embodiment of the present invention, a unique The present invention is described in enabling detail below.

For the purposes of the present invention, the Football Helmet Barbecue Grill should not be construed to be limited to barbecue, or charcoal grills. The Football Helmet Barbecue Grill 100, in some preferred embodiments can be equally expedient for use with other gas powered grills as well. As such, the present invention should not be construed to be limited to solely barbecue grills.

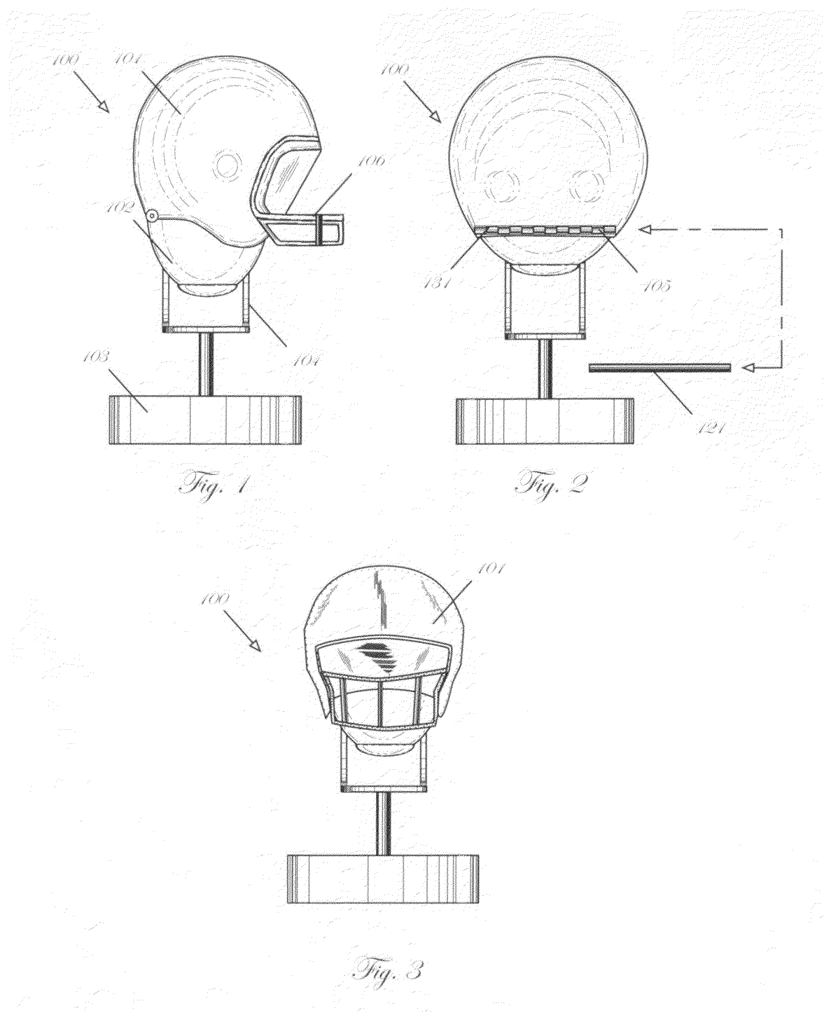

FIG. 1 illustrates a preferred embodiment of the present invention. A Football Helmet Barbecue Grill 100 includes a Football Shaped Hood 101, a Base Assembly 103, and a Grill Assembly 102. The Grill Assembly is affixed with the Base Assembly. In some preferred embodiments, the Football Shaped Hood further comprises a glass member 112 disposed near the facemask. This glass enables a user to monitor the progression of the cooking. Also, in some preferred embodiments, a Tray 125 is included for the purpose of supporting food, equipment, etc. The Tray 125 is disposed upon the facemask. In other preferred embodiments as illustrated in FIG. 8, the Tray is directly affixed with the Grill Assembly 102.

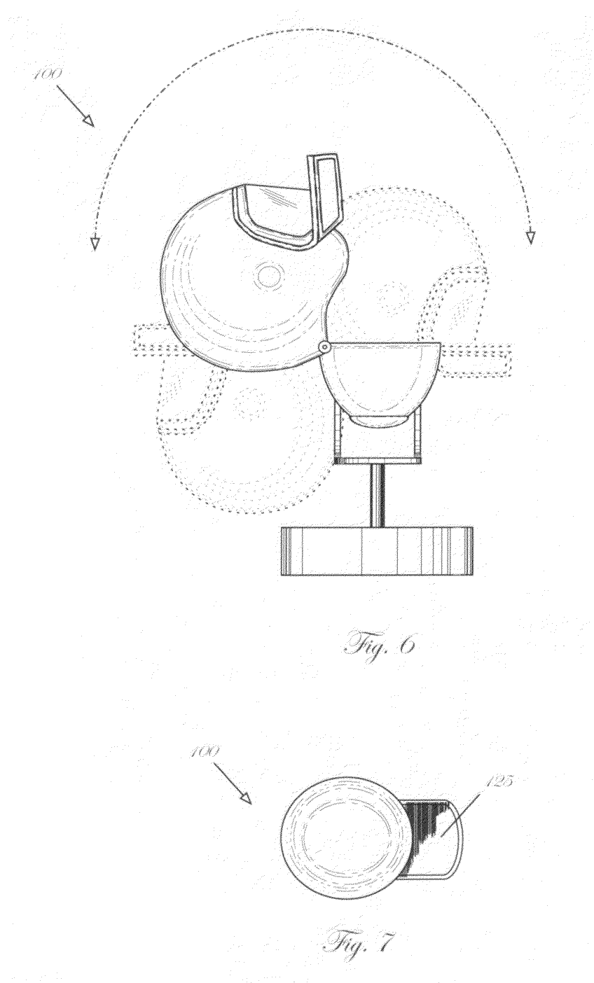

In some preferred embodiments, the Football Shaped Hood 101 is connected with the Grill Assembly 102 with a hinge assembly. The hinge assembly enables the Football Shaped Hood 101 to be articulated about the axis formed at the hinge as illustrated in FIG. 6. The hinge assembly is comprised of an elongate member 121 and a cooperating hinge 131 on the Football Shaped Hood 101. In some preferred embodiments, the cooperating hinge may be a series of interconnecting orifice forming flanges which is disposed on the posterior side of the Football Shaped Hood.

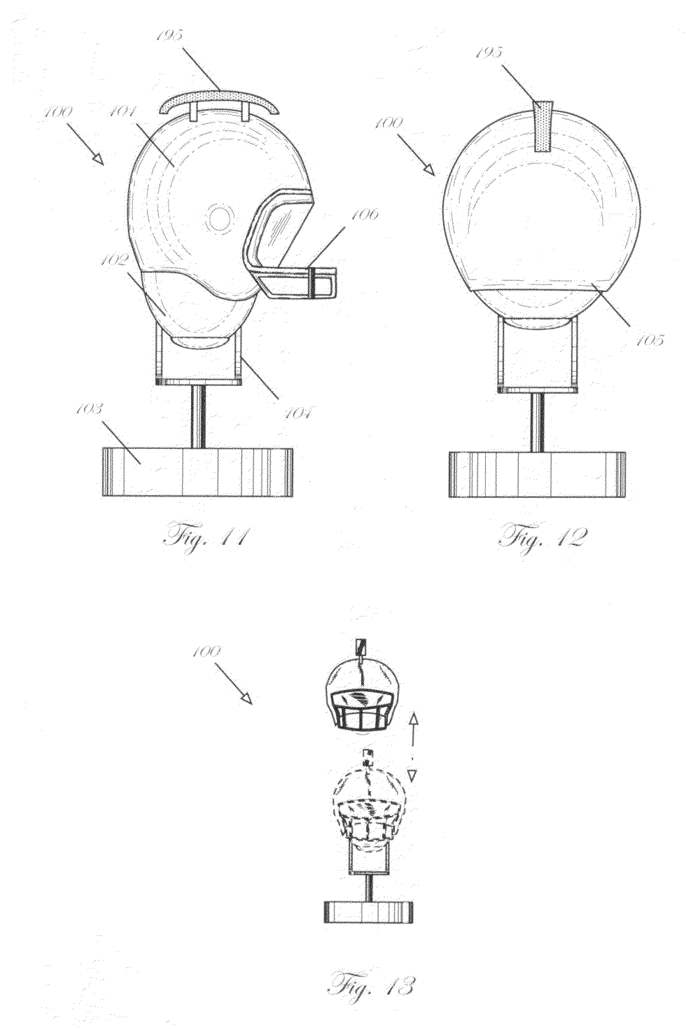

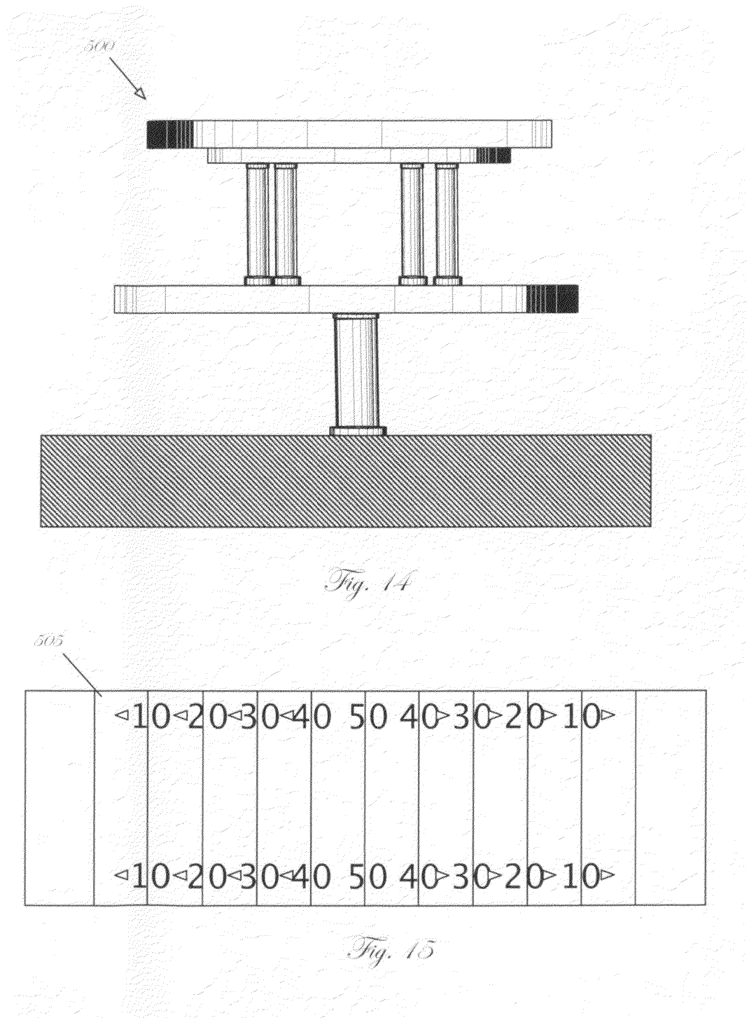

Alternatively, FIGS. 11-13 illustrate that in some preferred embodiments, the hinge may be replaced with a simple handle 195. In operation, a user can simply lift the Football Shaped Hood 101 with the handle 195 in order to cook the meat. The handle 195 is affixed to the top of the Football Shaped Hood 101. FIG. 11 illustrates that the handle can be curved in an arcuate shape in some preferred embodiments.

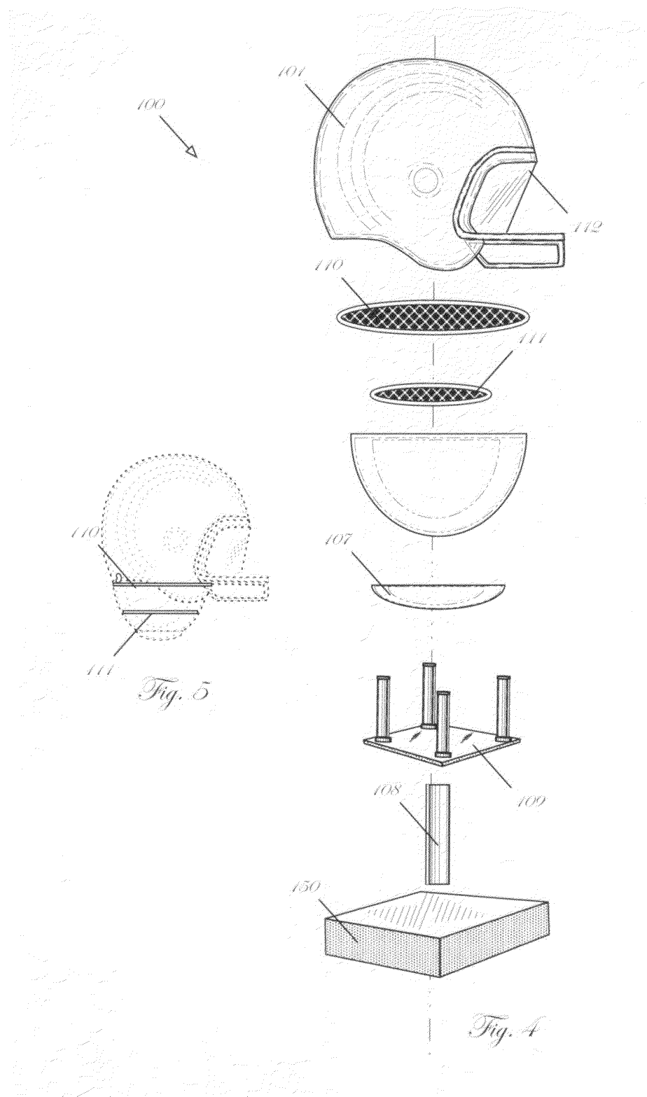

FIG. 4 illustrates that in some preferred embodiments, the Football Helmet Barbecue Grill 100 further includes a charcoal grate 111, and a cooking grate 110. The cooking grate is disposed above the charcoal grate and is housed within the Grill Assembly 102. FIG. 4 also illustrates that in some preferred embodiments, an ash bowl 107 is included and is disposed underneath the Grill Assembly 102.

FIG. 4 illustrates further illustrates that the Base Assembly 103 is comprised of a ballast member 150, a support member 108, a planar member 109, and at least two field goal members 104. The ballast member is connected with the support member. This connection, in some preferred embodiments can be made through a cooperating threading on both the support member and the ballast member. In some preferred embodiments, the ballast member is manufactured to have the requisite weight, surface area, and other supporting attributes to ensure a stable fulcrum upon which the rest of the grill is supported.

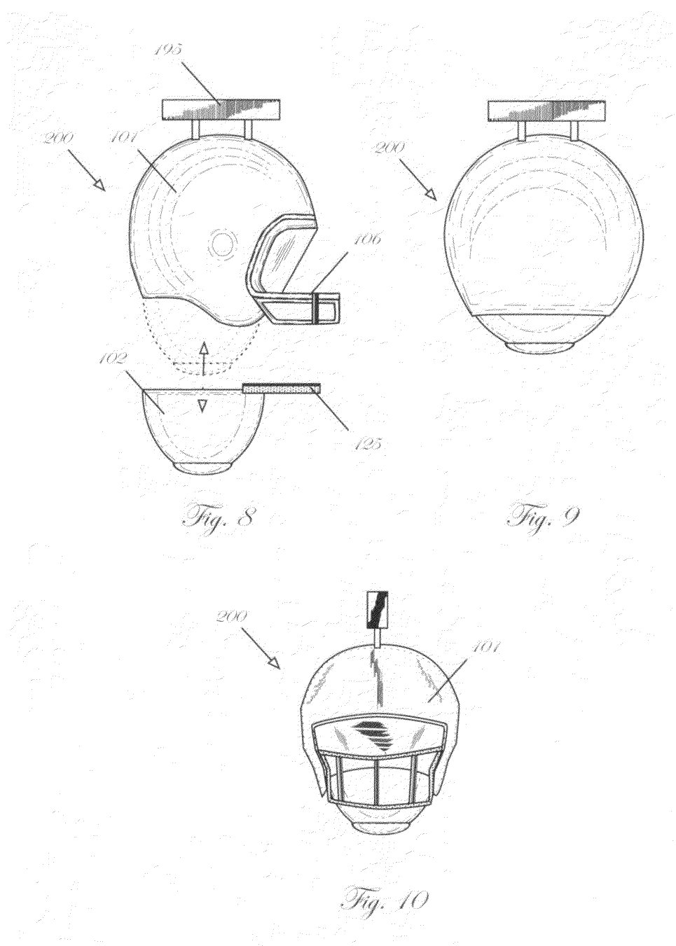

FIGS. 8-10 illustrate that in some preferred embodiments, the Base Assembly 103 is removed. The resulting apparatus is consequently a Football Helmet Themed Hibachi Grill 200. The Football Helmet Themed Hibachi Grill 200, for obvious reasons incorporates a handle 195.

The support member is connected with the planar member. Again, this connection can be made through a cooperating threading of both parts. In some preferred embodiments, this connection can even be facilitated through use of detents. The planar member supports the field goal members. In some preferred embodiments, there may be as many as four field goal members to closely resemble field goal crossbars used in football. It should also be noted here, that in some preferred embodiments, the support members and/or the field goal members may be telescoping to enhance the portability of the present invention.

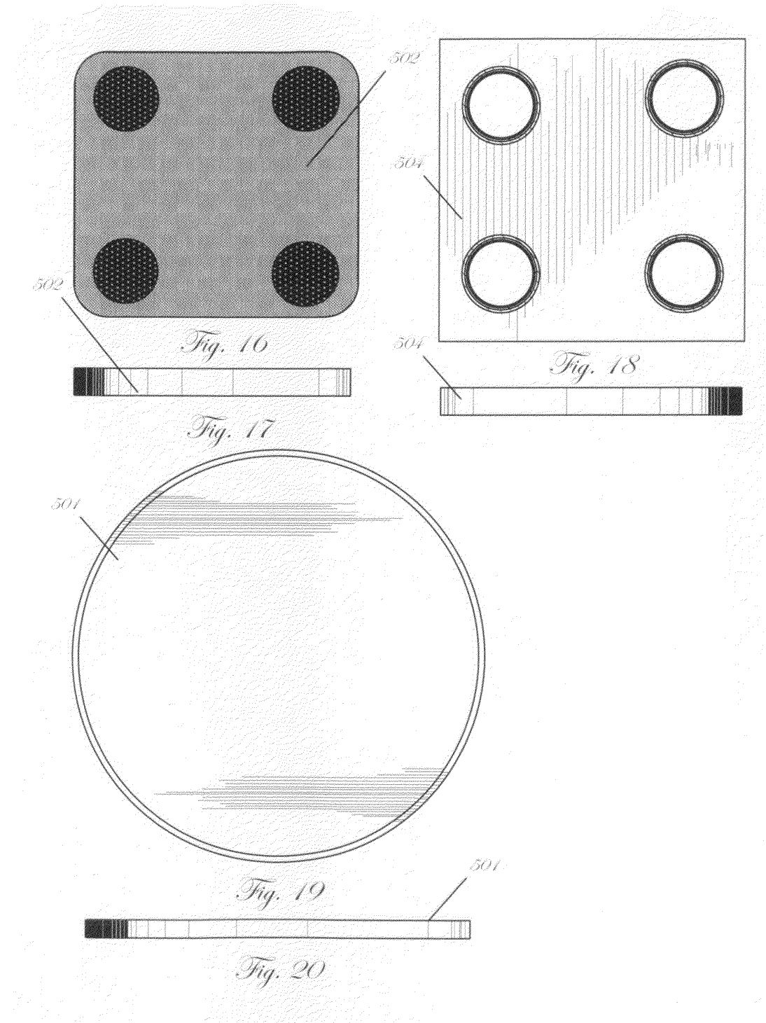

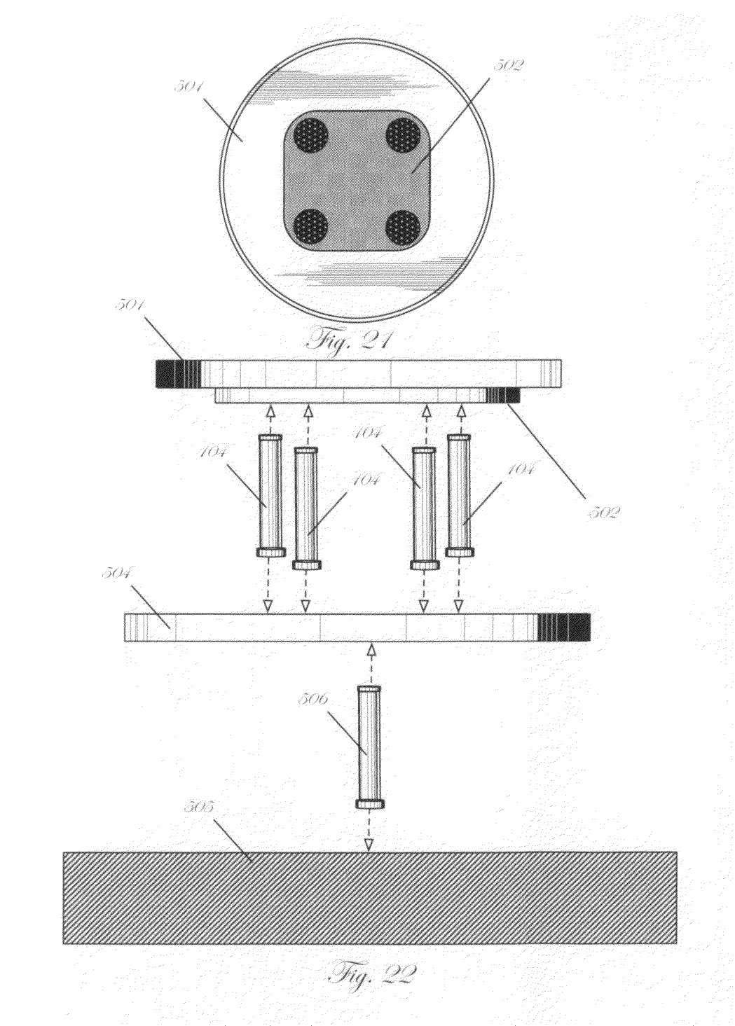

FIGS. 15-21 illustrate that in some preferred embodiments, the grill assembly may be removed to reveal an embodiment of a table. The Football Table Assembly includes a Table, and a Support Member. The Table is directly affixed to the support member. The support member has a plurality of orifices sized to mate with the Field Goal Members 104.

It will be apparent to the skilled artisan that there are numerous changes that may be made in embodiments described herein without departing from the spirit and scope of the invention. As such, the invention taught herein by specific examples is limited only by the scope of the claims that follow. In some preferred embodiments, the ballast member field can include numbers and hash marks to represent a football field. The hash marks may be made of bumps of metal, strings, or an extruded surface. In other preferred embodiments, the hash marks may be comprised of a series of lights. In other preferred embodiments, the hash marks and numbers may provided functionality as a series of wedges to hold crackers, chips, etc.

What is claimed is:

1. A Football Helmet Barbecue Grill comprising:
a Football Shaped Hood, a Base Assembly, and a Grill Assembly;
the Football Shaped Hood is connected with the Grill Assembly;
the Grill Assembly is affixed with the Base Assembly.

2. The Football Helmet Barbecue Grill of claim 1 further comprising a hinge assembly; the hinge assembly is comprised of an elongate member and a cooperating hinge on the Football Shaped Hood.

3. The Football Helmet Barbecue Grill of claim 1 further comprising a glass member; the glass member is affixed to the Football Shaped Helmet.

4. The Football Helmet Barbecue Grill of claim 1 further comprising a cooking grate and a charcoal grate; the cooking grate is disposed over the charcoal grate.

5. The Football Helmet Barbecue Grill of claim 1 further comprising an ash bowl; the ash bowl is disposed underneath the Grill Assembly.

6. The Football Helmet Barbecue Grill of claim 1 wherein the Base Assembly is comprised of a ballast member, a support member, a planar member, and at least two field goal members; the ballast member is connected with the support member, the support member is connected with the planar member, and the planar member supports the field goal members.
